(19) United States
(12) Patent Application Publication
(10) Pub. No.: US 2021/0326647 A1
(43) Pub. Date: Oct. 21, 2021

(54) DEVICE AND METHOD TO IMPROVE THE ROBUSTNESS AGAINST 'ADVERSARIAL EXAMPLES'

(71) Applicants: Robert Bosch GmbH, Stuttgart (DE); Carnegie Mellon University, Pittsburgh, PA (US)

(72) Inventors: Frank Schmidt, Leonberg (DE); Eric Wong, Lexington, MA (US); Jeremy Zieg Kolter, Pittsburgh, PA (US)

(21) Appl. No.: 17/267,638

(22) PCT Filed: Nov. 27, 2019
(86) PCT No.: PCT/EP2019/082757

§ 371 Date: Feb. 10, 2021

(30) Foreign Application Priority Data
Dec. 19, 2018 (EP) 18213925.3

(51) Int. Cl. G06K 9/62; G06N 3/08

(52) U.S. Cl. CPC G06K 9/6256; G06N 3/08; G06K 9/6262; G06K 9/6271

(57) ABSTRACT

A computer-implemented method for obtaining an adversarial input signal to a classifier for classifying input signals obtained from a sensor. The adversarial input signal is obtained from an original input signal. The adversarial input signal and the original input signal cause the classifier to classify the original input signal as belonging to a first class and the adversarial input signal as belonging to a second class different from said first class. The method includes: modifying said original input signal to yield a modified input signal; projecting said modified input signal onto a metric ball around said original input signal to yield a projected input signal; and obtaining said adversarial input signal depending on the projected input signal, characterized in that the metric is an at least approximate Wasserstein distance.

### FIELD

The present invention concerns a method for obtaining an adversarial input signal, a method for using and/or training a classifier, a method for assessing a robustness of said classifier, and a method for operating an actuator, a computer program and a machine-readable storage medium, a classifier, a control system, and a training system.

### BACKGROUND INFORMATION

U.S. Pat. No. 10,007,866 BB describes a method comprising: accessing, from a memory, a neural network image classifier, the neural network image classifier having been trained using a plurality of training images from an input space, the training images being labeled for a plurality of classes; computing a plurality of adversarial images by, for each adversarial image, searching a region in the input space around one of the training images, the region being one in which the neural network is linear, to find an image which is incorrectly classified into the plurality of classes by the neural network; applying the training image to the neural network and observing a response of the neural network; computing a constraint system which represents the input space using the observed response; and further training the neural network image classifier to have improved accuracy using at least the adversarial images.

“Universal Adversarial Perturbations Against Semantic Image Segmentation”, arXiv preprint arXiv:1704.05712v3, Jan Hendrik Metzen, Mummadi Chaithanya Kumar, Thomas Brox, Volker Fischer, describe a method for generating adversarial perturbations.

### SUMMARY

Classifiers, like, e.g., neural network classification systems can easily be fooled. It is well known that classifiers which may be based on deep learning may be sensitive to small perturbations. In order to deploy such systems in the physical world, it may be important to provide a proof about the system's robustness.

It is possible to compute robust classifiers with respect to adversarial noise that lies within a small Lₚ ball. Nonetheless, adversarials with respect to more natural perturbations are not necessarily covered by these robustness statements. More natural perturbations include partial translations, rotations and motion blur. Moving for example a dark object by one pixel will lead to a very large L_{∞}-distance if the background is very bright, but will usually be considered as a small change in the physical world. As a consequence, these small physical changes are not covered by L_{∞}-robustness.

Methods in accordance with example embodiments of the present invention may have the advantage to improve robustness with respect to such perturbations.

In a first aspect, the present invention therefore is concerned with a computer-implemented method for obtaining an adversarial input signal (x^{adv}) to a classifier for classifying input signals (x) to said classifier which, wherein said input signals (x) may have been obtained from a sensor, wherein said adversarial input signal (x^{adv}) is obtained from an original input signal (x^{org}) which may have been obtained from said sensor, and wherein said adversarial input signal (x^{adv}) and said original input signal (x^{org}) cause the classifier to classify said original input signal (x^{org}) as belonging to a first class ( [symbol] ₀) and said adversarial input signal (x^{adv}) as belonging to a second class ( [symbol] ) different from said first class ( [symbol] ₀), wherein the method comprises the steps of:
modifying said original input signal (x^{org}) to yield a modified input signal (x^{mod});
projecting said modified input signal (x^{mod}) onto a metric ball around (e.g. centered around) said original input signal (x^{org}) to yield a projected input signal (x^{proj});
obtaining said adversarial input signal (x^{adv}) depending on said projected input signal (x^{proj}), characterized in that said metric is an at least approximate Wasserstein distance.

The term “projecting a given point onto a metric ball” may be construed to mean “determining a point from said metric ball that is closest to said given point”.

Said at least approximate Wasserstein distance may be characterized by predefined parameters, like e.g. a predefined radius.

Said Wasserstein distance is hard to compute, and it has not been known so far how to carry out a projection on a Wasserstein ball.

It is therefore proposed to determine said projected input signal (x^{proj}) by minimizing a distance to said modified input signal (x^{mod}) under a constraint that a distance, for example measured by an L²-metric, according to said at least Wasserstein distance is not larger than a predefined radius (∈) of said metric ball.

This enables an exact solution, i.e., a solution where said at least approximate Wasserstein distance is a Wasserstein distance. Conveniently, said aforementioned minimization may be obtained by maximizing a dual problem corresponding to a primal problem that is given by said minimization under said constraints, wherein said dual problem comprises a Langrangian multiplier variable corresponding to said constraints. This is described in detail in FIG. 13 and the corresponding description.

In a preferred embodiment, said at least approximate Wasserstein distance is a Sinkhorn distance which differs from a Wasserstein distance by an entropic term, wherein for any pair of first distribution (P) and second distribution (Q), said entropic term characterizes an entropy of a distribution H that satisfies Π1ₙ=P, Π^{T}1ₙ=Q. If P and Q are distributions defined over the same domain Ω, then Π is a distribution over the domain Q×Q with P and Q as its marginals.

It has been discovered that the inclusion of said entropic term enables an approximate solution to the projection on a Wasserstein ball that is a lot faster to compute.

It should be noted that, as described in “Sinkhorn Distances: Lightspeed Computation of Optimal Transportation Distances”, arXiv preprint arXiv: 1306.0895v1, Marco Cuturi (2013), a Sinkhorn distance is in fact not a metric in the mathematical sense, since it is possible to have a zero distance between two distributions that are not the same. Instead, in a mathematical sense, it is a pseudo-metric.

In fact, it has been discovered that a good way for determining said projected input signal (x^{proj}) by solving a convex optimization corresponding to said minimization under said constraints. This is described in detail in the description corresponding to FIG. 14.

In one further aspect of the present invention, said adversarial input signal (x^{adv}) may be provided by a targeted attack, i.e., provided to cause said classifier to classify it as belonging to a predefined second class. An efficient way for doing so can be provided if said classifier when provided with said input signal (x), is configured to output a first classification value (fₗ_{₀}) corresponding to said first class ( [symbol] ₀) and a second classification value (fₗ) corresponding to said a predefined second class ( [symbol] ). In this sense, it may be said that said input signal (x) causes said first and/or second classification value. A robust way to generate said targeted misclassification is by determining said modified input signal (x^{mod}) such as to cause a difference (g) between said first classification value (fₗ_{₀}) and said second classification value (fₗ) to be smaller than the difference (g) caused by said original input signal (x^{org}). Conveniently, this may be achieved by determining said modified input signal (x^{mod}) depending on a gradient (∇g) of said difference (g).

In alternative embodiment to said targeted attack, said adversarial input signal (x^{adv}) may be provided by an untargeted attack, i.e., provided to cause said classifier to classify it as belonging to any different second class. In this case, conveniently said modified input signal (x^{mod}) is provided such as to cause said first classification value (fₗ_{₀}) to be smaller than said first classification value (fₗ_{₀}) caused by said original input signal (x^{org}). Conveniently, this may be achieved by determining said modified input signal (x^{mod}) depending on a gradient (∇fₗ_{₀}) of said first classification value (fₗ_{₀}).

In a further aspect of the present invention, the steps of modifying said original input signal (x^{org}) to yield said modified input signal (x^{mod}) and projecting said modified input signal (x^{mod}) onto said predefined subset to yield said projected input signal (x^{proj}) are carried out iteratively by using said projected input signal (x^{proj}) of a preceding iteration as original input signal (x^{org}) a subsequent iteration, wherein said step projecting said modified input signal (x^{mod}) onto said predefined subset is carried out after each step of modifying said original input signal (x^{org}). Such an iterative method is preferable, because it ensures that intermediate modified input signal (x^{mod}) remain close to a boundary of the at least approximate Wasserstein ball, thus enhancing convergence of the method.

Embodiments of the present invention are discussed with reference to the figures in more detail.

### BRIEF DESCRIPTION OF THE DRAWINGS

FIG. 1 shows a control system having a classifier controlling an actuator in its environment, in accordance with an example embodiment of the present invention.

FIG. 2 shows the control system controlling an at least partially autonomous robot, in accordance with an example embodiment of the present invention.

FIG. 3 shows the control system controlling a manufacturing machine, in accordance with an example embodiment of the present invention.

FIG. 4 shows the control system controlling an automated personal assistant, in accordance with an example embodiment of the present invention.

FIG. 5 shows the control system controlling an access control system, in accordance with an example embodiment of the present invention.

FIG. 6 shows the control system controlling a surveillance system, in accordance with an example embodiment of the present invention.

FIG. 7 shows the control system controlling an imaging system, in accordance with an example embodiment of the present invention.

FIG. 8 shows a training system for controlling the classifier, in accordance with an example embodiment of the present invention.

FIG. 9 shows a flow-chart diagram of a training method carried out by said training system, in accordance with an example embodiment of the present invention.

FIG. 10 shows a flow-chart diagram illustrating a method for operating said control system, in accordance with an example embodiment of the present invention.

FIG. 11 shows an embodiment of a structure of said classifier, in accordance with an example embodiment of the present invention.

FIG. 12 shows a flow-chart diagram illustrating a method for determining said adversarial input signal x^{adv} in accordance with an example embodiment of the present invention.

FIG. 13 shows a flow-chart diagram illustrating a method for projecting a modified input signal x^{mod} onto a Wasserstein ball, in accordance with an example embodiment of the present invention.

FIG. 14 shows a flow-chart diagram illustrating a method for projecting a modified input signal x^{mod} onto a Sinkhorn ball, in accordance with an example embodiment of the present invention.

FIG. 15 shows a flow-chart diagram illustrating a method for computing II as defined in equation (2) from the maximizing values Φ*, Ψ*, ρ* that solve equation (5), in accordance with an example embodiment of the present invention.

### DETAILED DESCRIPTION OF EXAMPLE EMBODIMENT

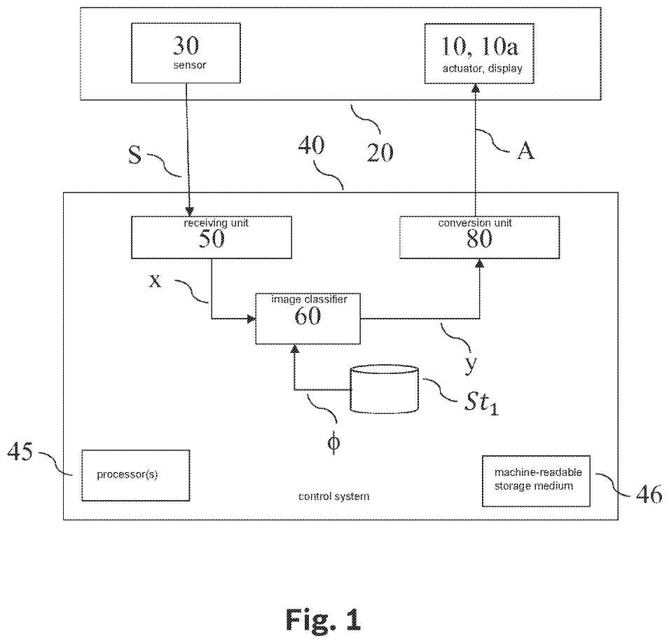

Shown in FIG. 1 is one example embodiment of an actuator 10 in its environment 20, in accordance with the present invention. Actuator 10 interacts with a control system 40. Actuator 10 and its environment 20 will be jointly called actuator system. At preferably evenly spaced distances, a sensor 30 senses a condition of the actuator system. The sensor 30 may comprise several sensors. Preferably, sensor 30 is an optical sensor that takes images of the environment 20. An output signal S of sensor 30 (or, in case the sensor 30 comprises a plurality of sensors, an output signal S for each of the sensors) which encodes the sensed condition is transmitted to the control system 40.

Thereby, control system 40 receives a stream of sensor signals S. It then computes a series of actuator control commands A depending on the stream of sensor signals S, which are then transmitted to actuator 10.

Control system 40 receives the stream of sensor signals S of sensor 30 in an optional receiving unit 50.

Receiving unit 50 transforms the sensor signals S into input signals x. Alternatively, in case of no receiving unit 50, each sensor signal S may directly be taken as an input signal x. Input signal x may, for example, be given as an excerpt from sensor signal S. Alternatively, sensor signal S may be processed to yield input signal x. Input signal x comprises image data corresponding to an image recorded by sensor 30. In other words, input signal x is provided in accordance with sensor signal S.

Input signal x is then passed on to an image classifier 60, which may, for example, be given by an artificial neural network.

Classifier 60 is parametrized by parameters ϕ, which are stored in and provided by parameter storage St₁.

Classifier 60 determines output signals y from input signals x. The output signal y comprises information that assigns one or more labels to the input signal x Output signals y are transmitted to an optional conversion unit 80, which converts the output signals y into the control commands A. Actuator control commands A are then transmitted to actuator 10 for controlling actuator 10 accordingly. Alternatively, output signals y may directly be taken as control commands A.

Actuator 10 receives actuator control commands A, is controlled accordingly and carries out an action corresponding to actuator control commands A. Actuator 10 may comprise a control logic which transforms actuator control command A into a further control command, which is then used to control actuator 10.

In further embodiments, control system 40 may comprise sensor 30. In even further embodiments, control system 40 alternatively or additionally may comprise actuator 10.

In still further embodiments, it may be envisioned that control system 40 controls a display 10a instead of an actuator 10.

Furthermore, control system 40 may comprise a processor 45 (or a plurality of processors) and at least one machine-readable storage medium 46 on which instructions are stored which, if carried out, cause control system 40 to carry out a method according to one aspect of the invention.

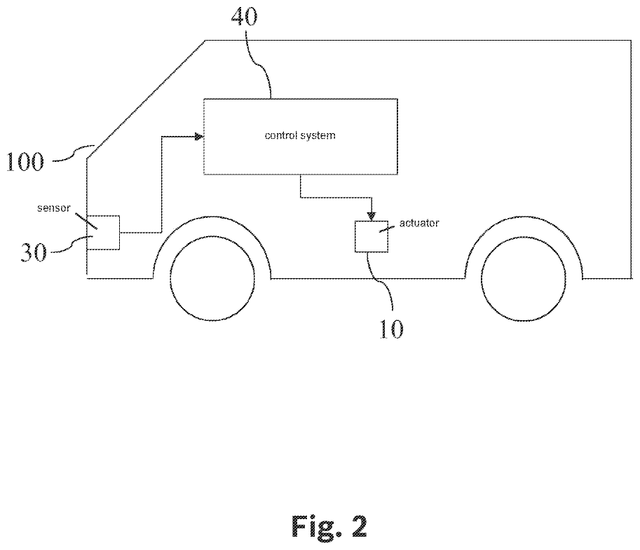

FIG. 2 shows an embodiment in which control system 40 is used to control an at least partially autonomous robot, e.g., an at least partially autonomous vehicle 100.

Sensor 30 may comprise one or more video sensors and/or one or more radar sensors and/or one or more ultrasonic sensors and/or one or more LiDAR sensors and or one or more position sensors (like e.g. GPS). Some or all of these sensors are preferably but not necessarily integrated in vehicle 100.

Alternatively or additionally sensor 30 may comprise an information system for determining a state of the actuator system. One example for such an information system is a weather information system which determines a present or future state of the weather in environment 20.

For example, using input signal x, the classifier 60 may for example detect objects in the vicinity of the at least partially autonomous robot. Output signal y may comprise an information which characterizes where objects are located in the vicinity of the at least partially autonomous robot. Control command A may then be determined in accordance with this information, for example to avoid collisions with said detected objects.

Actuator 10, which is preferably integrated in vehicle 100, may be given by a brake, a propulsion system, an engine, a drivetrain, or a steering of vehicle 100. Actuator control commands A may be determined such that actuator (or actuators) 10 is/are controlled such that vehicle 100 avoids collisions with said detected objects. Detected objects may also be classified according to what the classifier 60 deems them most likely to be, e.g. pedestrians or trees, and actuator control commands A may be determined depending on the classification.

In further embodiments, the at least partially autonomous robot may be given by another mobile robot (not shown), which may, for example, move by flying, swimming, diving or stepping. The mobile robot may, inter alia, be an at least partially autonomous lawn mower, or an at least partially autonomous cleaning robot. In all of the above embodiments, actuator command control A may be determined such that propulsion unit and/or steering and/or brake of the mobile robot are controlled such that the mobile robot may avoid collisions with said identified objects.

In a further embodiment, the at least partially autonomous robot may be given by a gardening robot (not shown), which uses sensor 30, preferably an optical sensor, to determine a state of plants in the environment 20. Actuator 10 may be a nozzle for spraying chemicals. Depending on an identified species and/or an identified state of the plants, an actuator control command A may be determined to cause actuator 10 to spray the plants with a suitable quantity of suitable chemicals.

In even further embodiments, the at least partially autonomous robot may be given by a domestic appliance (not shown), like e.g. a washing machine, a stove, an oven, a microwave, or a dishwasher. Sensor 30, e.g. an optical sensor, may detect a state of an object which is to undergo processing by the household appliance. For example, in the case of the domestic appliance being a washing machine, sensor 30 may detect a state of the laundry inside the washing machine. Actuator control signal A may then be determined depending on a detected material of the laundry.

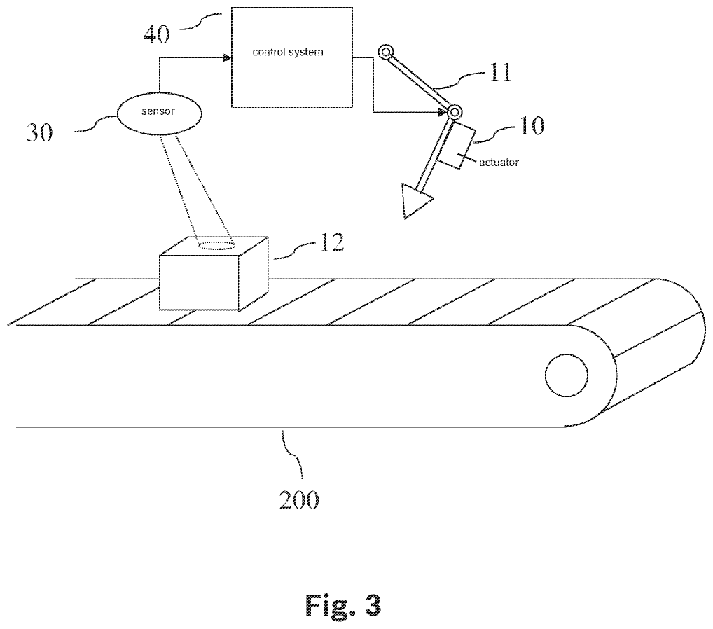

Shown in FIG. 3 is an embodiment in which control system 40 is used to control a manufacturing machine 11, e.g. a punch cutter, a cutter or a gun drill) of a manufacturing system 200, e.g. as part of a production line. The control system 40 controls an actuator 10 which in turn control the manufacturing machine 11.

Sensor 30 may be given by an optical sensor which captures properties of e.g. a manufactured product 12. Classifier 60 may determine a state of the manufactured product 12 from these captured properties. Actuator 10 which controls manufacturing machine 11 may then be controlled depending on the determined state of the manufactured product 12 for a subsequent manufacturing step of manufactured product 12. Or, it may be envisioned that actuator 10 is controlled during manufacturing of a subsequent manufactured product 12 depending on the determined state of the manufactured product 12.

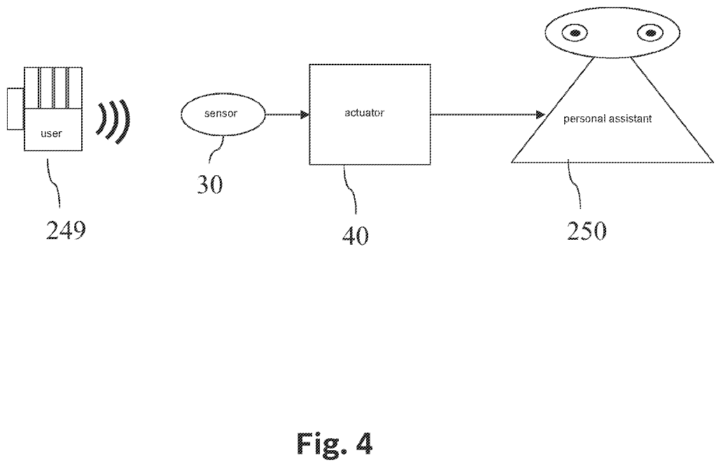

Shown in FIG. 4 is an embodiment in which control system 40 is used for controlling an automated personal assistant 250. Sensor 30 may be an optic sensor, e.g. for receiving video images of a gestures of user 249. Alternatively, sensor 30 may also be an audio sensor e.g. for receiving a voice command of user 249.

Control system 40 then determines actuator control commands A for controlling the automated personal assistant 250. The actuator control commands A are determined in accordance with sensor signal S of sensor 30. Sensor signal S is transmitted to the control system 40. For example, classifier 60 may be configured to e.g. carry out a gesture recognition algorithm to identify a gesture made by user 249. Control system 40 may then determine an actuator control command A for transmission to the automated personal assistant 250. It then transmits said actuator control command A to the automated personal assistant 250.

For example, actuator control command A may be determined in accordance with the identified user gesture recognized by classifier 60. It may then comprise information that causes the automated personal assistant 250 to retrieve information from a database and output this retrieved information in a form suitable for reception by user 249.

In further embodiments, it may be envisioned that instead of the automated personal assistant 250, control system 40 controls a domestic appliance (not shown) controlled in accordance with the identified user gesture. The domestic appliance may be a washing machine, a stove, an oven, a microwave or a dishwasher.

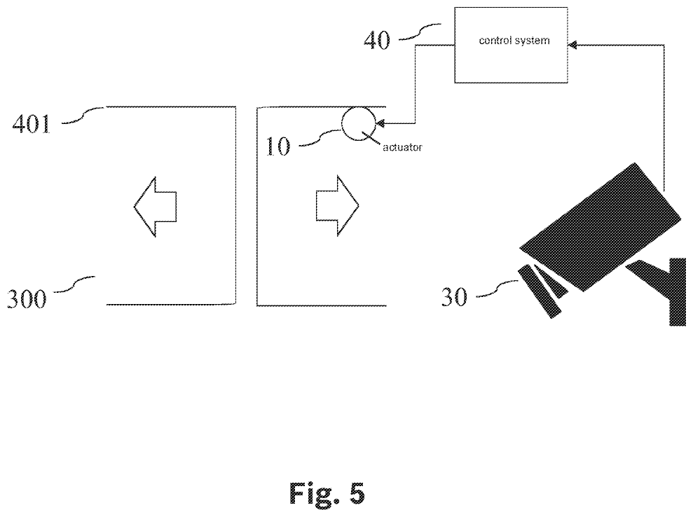

Shown in FIG. 5 is an embodiment in which control system controls an access control system 300. Access control system may be designed to physically control access. It may, for example, comprise a door 401. Sensor 30 is configured to detect a scene that is relevant for deciding whether access is to be granted or not. It may for example be an optical sensor for providing image or video data, for detecting a person's face. Classifier 60 may be configured to interpret this image or video data e.g. by matching identities with known people stored in a database, thereby determining an identity of the person. Actuator control signal A may then be determined depending on the interpretation of classifier 60, e.g. in accordance with the determined identity. Actuator 10 may be a lock which grants access or not depending on actuator control signal A. A non-physical, logical access control is also possible.

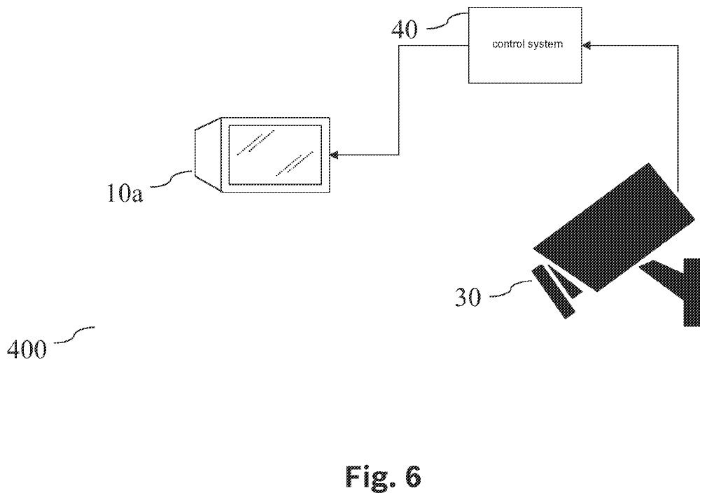

Shown in FIG. 6 is an embodiment in which control system 40 controls a surveillance system 400. This embodiment is largely identical to the embodiment shown in FIG. 5. Therefore, only the differing aspects will be described in detail. Sensor 30 is configured to detect a scene that is under surveillance. Control system does not necessarily control an actuator 10, but a display 10a. For example, the machine learning system 60 may determine a classification of a scene, e.g. whether the scene detected by optical sensor 30 is suspicious. Actuator control signal A which is transmitted to display 10a may then e.g. be configured to cause display 10a to adjust the displayed content dependent on the determined classification, e.g. to highlight an object that is deemed suspicious by machine learning system 60.

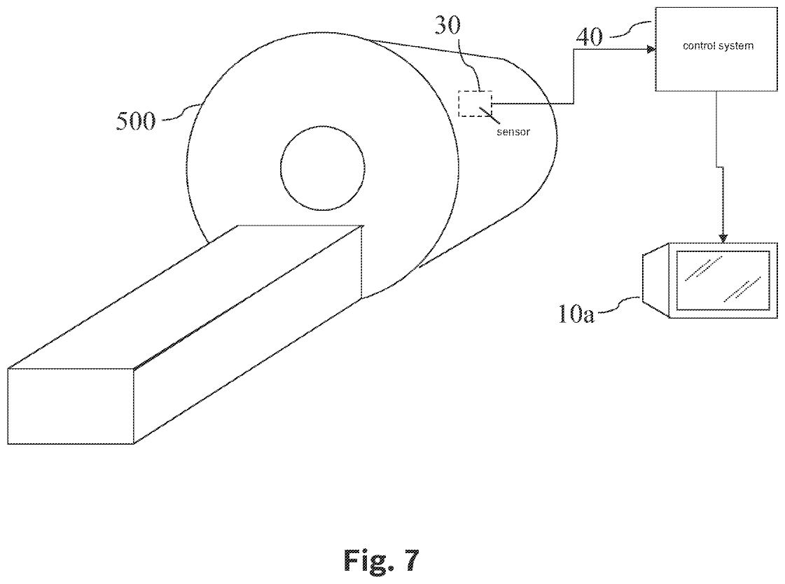

Shown in FIG. 7 is an embodiment of a control system 40 for controlling an imaging system 500, for example an MRI apparatus, x-ray imaging apparatus or ultrasonic imaging apparatus. Sensor 30 may, for example, be an imaging sensor. Machine learning system 60 may then determine a classification of all or part of the sensed image. Actuator control signal A may then be chosen in accordance with this classification, thereby controlling display 10a. For example, machine learning system 60 may interpret a region of the sensed image to be potentially anomalous. In this case, actuator control signal A may be determined to cause display 10a to display the imaging and highlighting the potentially anomalous region.

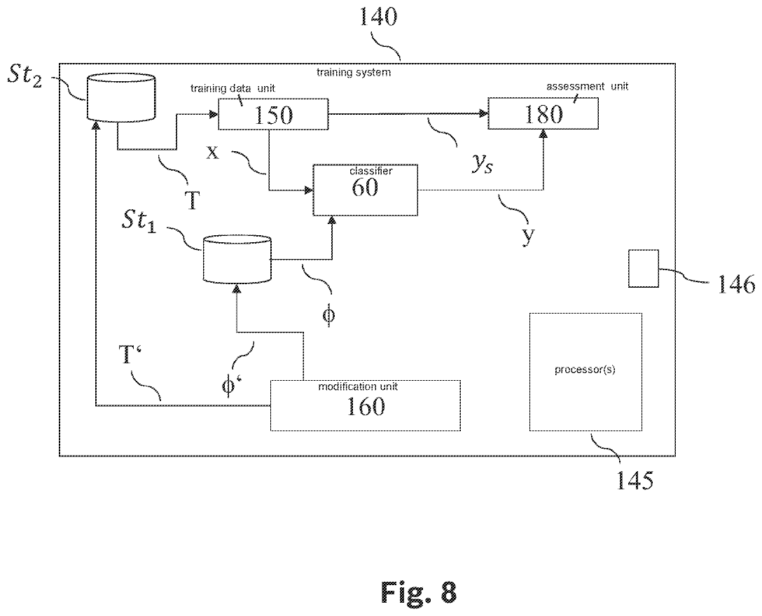

Shown in FIG. 8 is an embodiment of a training system 140 for training classifier 60. A training data unit 150 determines input signals x, which are passed on to classifier 60. For example, training data unit 150 may access a computer implemented database St₂ in which a set T of training data is stored. Set T comprises pairs of input signal x and corresponding desired output signal yₛ. Training data unit 150 selects samples from set T, e.g. randomly. Input signal x of a selected sample is passed on to classifier 60. Desired output signal yₛ is passed on to assessment unit 180.

Classifier 60 is configured to compute output signals y from input signals x. These output signals x are also passed on to assessment unit 180.

A modification unit 160 determines updated parameters ϕ′ depending on input from assessment unit 180. Updated parameters ϕ′ are transmitted to parameter storage St₁ to replace present parameters ϕ.

For example, it may be envisioned that assessment unit 180 determines the value of a loss function [symbol] depending on output signals y and desired output signals yₛ. Modification unit 160 may then compute updated parameters ϕ′ using e.g. stochastic gradient descent to optimize the loss function L [symbol] .

Furthermore, modification unit 160 may compute an adversarial dataset T′ comprising modified input signals x^{adv} based on original input signals x taken, for example, from training set T and their respective desired output signals yₛ.

Furthermore, training system 140 may comprise a processor 145 (or a plurality of processors) and at least one machine-readable storage medium 146 on which instructions are stored which, if carried out, cause control system 140 to carry out a method according to one aspect of the invention.

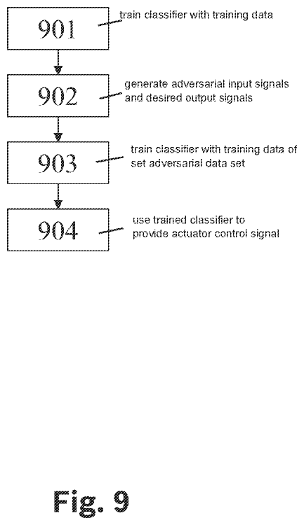

Shown in FIG. 9 is a flow-chart diagram of an embodiment of the method for training classifier 60, what may be implemented by training system 140.

First (901), classifier 60 is trained with training data of set T in a conventional manner, as discussed above.

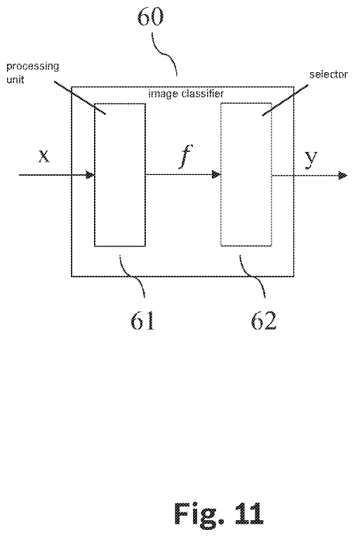

Then (902), one or more adversarial input signals x^{adv} and corresponding desired output signals yₛ are generated with the method according illustrated in FIG. 11 by modifying input signals from data set T and leaving the corresponding desired output signal yₛ unchanged. These one or more pairs of adversarial input signal x^{adv} and corresponding desired output signals y are added to adversarial dataset T′.

Now (903), classifier 60 is trained with training data of set adversarial dataset T′. The trained classifier 60 may then (904) be used for providing an actuator control signal A by receiving sensor signal S comprising data from sensor 30, determining the input signal x depending on said sensor signal S, and feeding said input signal x into classifier 60 to obtain output signal y that characterizes a classification of input signal x. Actuator 10 or 10a may then be controlled in accordance with provided actuator control signal A. This concludes the method.

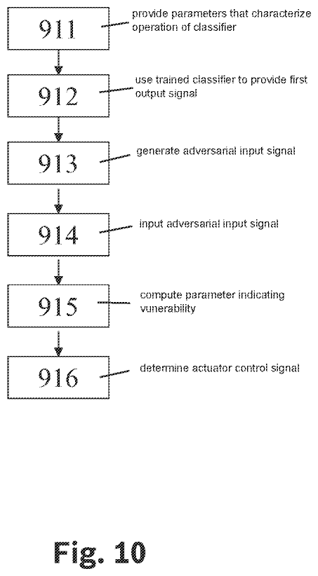

Shown in FIG. 10 is a flow-chart diagram of an embodiment of the method for operating classifier 60, which may be implemented by control system 40.

First (911), parameters 4 that characterize the operation of classifier 60 are provided. Conventionally, they are obtained by a training method for training classifier 60, e.g. by supervised training as outlined above.

The trained classifier 60 may then (912) be used for providing a first output signal y1 by receiving sensor signal S comprising data from sensor 30, determining the input signal x depending on said sensor signal S, and inputting said input signal x into classifier 60 to obtain first output signal y1 that characterizes a classification of input signal x.

Then (913), an adversarial input signal x^{adv} is generated with the method according illustrated in FIG. 11 by modifying input signal x.

This adversarial input signal x^{adv} is then (914) inputted into classifier 60 to obtain a second output signal y2 that characterizes a classification of adversarial input signal x^{adv}.

Next (915), a parameter vu indicating a vulnerability of classifier 60 is computed based on said first output signal y1 and said second output signal y2. For example, it is possible to set said parameter vu to a first value (for example “1”) indicating a vulnerability, if said first output signal y1 is not equal to said second output signal y2, and equal to a first value (for example “0”) indicating a non-vulnerability, if said first output signal y1 is equal to said second output signal y2.

An actuator control signal (A) may then (916) be determined in accordance with said parameter vu, and actuator (10) may be controlled in accordance with said actuator control signal (A). For example, if said parameter vu indicates a non-vulnerability, said actuator control signal (A) may then be determined to correspond to normal operation mode, whereas, if said parameter vu indicates a vulnerability, said actuator control signal (A) may then be determined to correspond to a fail-safe operation mode, by e.g. reducing a dynamics of a motion of said actuator (10).

FIG. 11 illustrates schematically a structure of one embodiment of classifier 60. Input signal x is inputted into processing unit 61, which may, for example, be given by all but the last layer of a neural network. Processing unit 61 is configured to output a vector f comprising preferably at least one entry [symbol] for each of the possible classes [symbol] for classification. Said vector f is inputted into a selector 62, which may be given, e.g., by an implementation of an argmax function. Selector 62 is configured to output signal y, which corresponds to the class corresponding to that one of the entries [symbol] of vector f that has the highest value. To highlight the dependence on input signal x, vector f will also be denoted f(x).

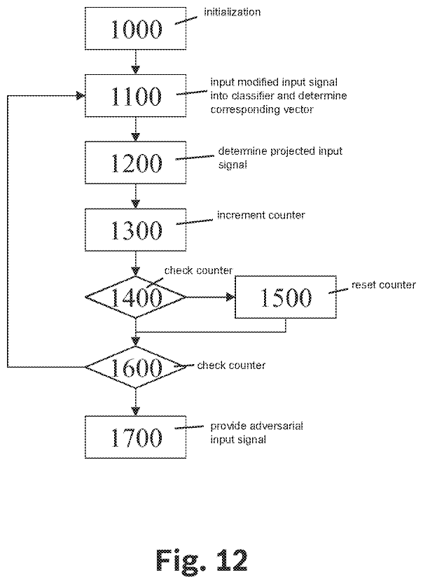

FIG. 12 illustrates a method for determining an adversarial input signal x^{adv} based on a given input signal x, which will also be called original input signal x^{org}. This method may be implemented by control system 40 or by training system 140. In an initialization step (1000), a counter variable may be initialized as counter=0, a step size τ may be initialized as e.g. τ=20 and a modified input signal x^{mod} may be initialized as x^{mod}=x. Original input signal x^{org} is inputted into classifier 60 and resulting output signal y is determined. A correct classification [symbol] ₀ is initialized as [symbol] ₀=y. A target classification [symbol] ≠ [symbol] ₀ may be selected either randomly or e.g. by setting it to a predefined value, or by selecting it as that classification [symbol] ≠ [symbol] ₀ that is closest to correct classification [symbol] ₀. For example, target classification [symbol] may be determined as that classification that corresponds to the second largest entry [symbol] of vector f. May be targeted or untargeted attack

Then (1100), modified input signal x^{mod} inputted into classifier 60 and corresponding vector f(x^{mod}) is determined. Then, a scalar function g(x)= [symbol] −f [symbol] ₀ is evaluated and its gradient ∇g(x)|ₓ₌ₓ_{^{mod}} is determined. Modified input signal x^{mod} may be updated as

x^{mod}=x^{mod}+τ·∇g(x)|ₓ₌ₓ_{^{mod}}. (1)

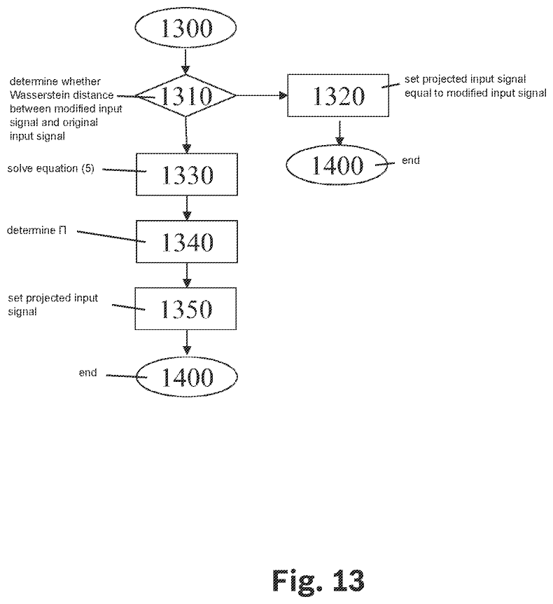

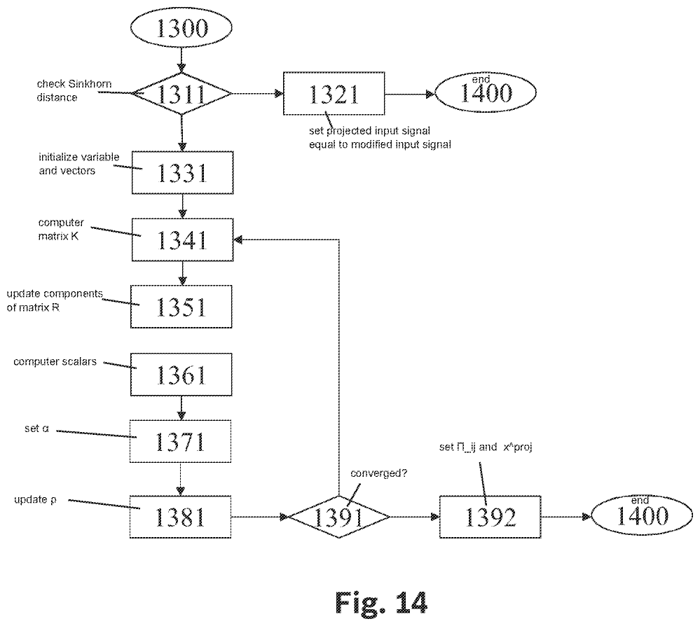

Next (1200), a projected input signal x^{proj} is be determined by projecting modified input signal x^{mod} onto a Wasserstein ball with a predefined radius ∈ centered around original input signal x^{org}. This projection may be carried out with one of the methods illustrated in FIGS. 13 and 14.

Then (1300), the counter is incremented counter←counter+1 and it is checked (1400), if the counter is a multiple of a predefined number, e.g. 20. If that is the case (1500), the counter is reset to counter=0 and step size τ is increased by a predefined factor, e.g. τ←τ·1.1.

Both of steps (1400) and (1500) are followed by checking (1600) whether the counter is less than a predefined maximum counter counterₘₐₓ, i.e., if counter<counterₘₐₓ. Furthermore, modified input signal x^{mod} is set equal to projected input signal x^{proj}, and scalar g(x^{mod}) is evaluated. If counter<counterₘₐₓ and if g(x^{mod})≤ub with an upper bound ub which may be set to any non-negative number, e.g. ub=0 (i.e., classification has not changed from correct classification [symbol] ₀ to target classification [symbol] , the method iterates back to step (1200). If not (1700), adversarial input signal x^{adv} is provided as equal to modified input signal x^{mod}. Optionally, if g(x^{adv})≤ub an error message may be provided indicating that no adversarial has been found with the desired confidence. This concludes the method.

FIG. 13 illustrates a method for determining projected input signal x^{proj} from modified input signal x^{mod}. This projection involves the computation of a Wasserstein distance W_{D}(P,Q) between two n-dimensional vectors P and Q which are given as P=(P₁, . . . , Pₙ) and Q=(Q₁, . . . , Qₙ). Distances between indices i and j are stored in a matrix Dᵢⱼ∈R^{n×n} (where Dᵢⱼ=∥i−j∥^{p} for some pre-defined value of p) and the Wasserstein distance W_{D}(P,Q) can be computed as

$${W}_{D} ( P , Q ) = {min}_{{{{R}^{n \times n} ∋ Π \geq 0}_{Π1 = P}}_{{Π}^{⊤} 1 = Q}} tr ( {Π}^{⊤} D ) = {max}_{{Φ , Ψ ∈ {R}^{n}}_{∀ i , j : {Φ}_{i} \leq {Ψ}_{j} + {D}_{ij}}} {P}^{⊤} Φ - {Q}^{⊤} Ψ . \qquad ( 2 )$$

(Here, the 1 in Π1=P, Π^{T}1=Q denotes an n-dimensional vector of ones). Determining said projected input signal x^{proj} then corresponds to solving equation

$${min}_{{W}_{D} ( {x}^{mod} , {x}^{{org}^{*}} ) \leq ∈} {L}_{2} ( {x}^{proj} , {x}^{org} ) . \qquad ( 3 )$$

(Of course, the L₂-metric may be replaced by any other metric).

First (1310), it is determined whether the Wasserstein distance W_{D}(x^{mod}, x^{org}) between modified input signal x^{mod} and original input signal x^{org} is not larger than predefined radius e, i.e., if

W_{D}(x^{mod},x^{org})≤∈. (4)

If that is the case (1320), projected input signal x^{proj} is set equal to modified input signal x^{mod}, and the method ends.

If that is not case (1330), and denoting P=x^{mod} and Q=x^{org}, equation

$${max}_{{Φ , Ψ ∈ {R}^{n} , ρ ∈ R}_{∀ i , j : {Φ}_{i} \leq {Ψ}_{j} + ρ \cdot {D}_{ij}}} {P}^{⊤} Φ - {Q}^{⊤} Ψ - [ \frac{1}{2} {\vert \vert Ψ \vert \vert}^{2} + ρ \cdot ϵ ] \qquad ( 5 )$$

is solved with e.g. projected gradient ascent to yield maximizing values Φ*, Ψ*, ρ*. It will be appreciated that equation (5) is a dual formulation to a primal problem given by equations (3) and (2).

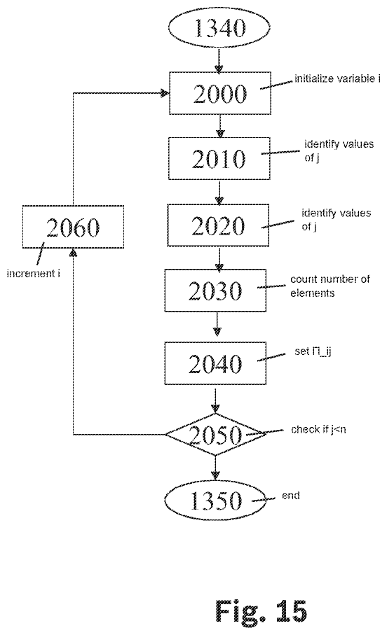

Next (1340), Π as defined in equation (2) is determined from the maximizing values Φ*, Ψ*, ρ* using e.g. the method illustrated in FIG. 15.

Then (1350), projected input signal x^{proj} is set equal to x^{proj}=Π^{T}1. This concludes the method.

FIG. 14 illustrates another, approximate but more efficient method, wherein instead of using a Wasserstein distance W_{D}(P,Q) as defined in equation (2) for defining the ball on which to project, one uses a Sinkhorn distance W_{D}^{λ}(P,Q) by subtracting an entropic term E_{T}, i.e.,

$$\begin{matrix}{W}_{D}^{λ} ( P , Q ) = {min}_{{{{R}^{n \times n} ∋ Π \geq 0}_{Π1 = P}}_{{Π}^{⊤} 1 = Q}} tr ( {Π}^{⊤} D ) + {E}_{T} , & ( 6 ) \\ {E}_{T} = \frac{1}{λ} {\sum }_{{Π}_{i j} > 0} {Π}_{i j} log ( {Π}_{i j} ) & ( 7 )\end{matrix}$$

with a predefined variable λ≠0, e.g. λ=1.

First (1311), it is determined whether the Sinkhorn distance W_{D}^{λ}(x^{mod},x^{org}) between modified input signal x^{mod} and original input signal x^{org} is not larger than predefined radius ∈, i.e., if

W_{D}^{λ}(x^{mod},x^{org})≤∈. (8)

If that is the case (1321), projected input signal x^{proj} is set equal to modified input signal x^{mod}, and the method ends.

If that is not case (1331), and denoting P=x^{mod} and Q=x^{org}, a variable ρ is initialized as ρ=1 and two n-dimensional vectors R, S are initialized by setting each of their components equal to e.g. Rᵢ=Sᵢ=1/n.

Then (1341), an exponential n×n-dimensional matrix K is computed as

K=exp(−λ·ρ·D). (9)

Next (1351), components Rᵢ of matrix R are updated as

Rᵢ=Pᵢ/(K·S)ᵢ (10)

and components Sᵢ of matrix S are updated as

$${S}_{i} = {W}_{0} ( exp ( λ {Q}_{i} - \frac{1}{2} ) \cdot {tmp}_{i} ) / {tmp}_{i} \qquad ( 11 )$$

with

tmp=λK^{T}R. (12)

Then (1361), scalars g and h are computed as

g= [symbol] R,DKS [symbol] −∈ [symbol] (13)

h=−λ [symbol] R,DDKS [symbol] (14)

where [symbol] . . . [symbol] denotes a scalar product, i.e., entry-wise multiplication followed by a sum over all multiplied entries. A value α is set to a positive value, e.g. α=1.

Then (1371), α is set such that

$$ρ \approx α \frac{g}{h}$$

but also

$$ρ \geq α \frac{g}{h} ,$$

e.g. by updating

$$α ← \frac{α}{2}$$

as long as

$$ρ < α \frac{g}{h} .$$

Now (1381), ρ is updated as

$$ρ ← ρ - α \frac{g}{h} .$$

Next (1391), it is checked whether the method as converged, e.g., if changes to R and/or S over the last iteration are sufficiently small (e.g. less than a predefined threshold). If that is not the case, the method iterates back to step (1341). If the method has converged, however, step (1392) follows.

In this step, one sets

Πᵢⱼ= [symbol] Rᵢ,K·Sᵢ [symbol] (15)

x^{proj}=Π^{T}1 (16)

This concludes the method.

FIG. 15 illustrates an embodiment to compute Π as defined in equation (2) from the maximizing values Φ, Ψ*, ρ* as obtained from the solution of equation (5) in step (1330). First (2000), variable i is initialized as i=1. Then (2010), all values of j∈{1, . . . , n} are identified for which Φ*ᵢ<Ψ*ⱼ+ρ*·Dᵢⱼ holds. If it does, the corresponding component Πᵢⱼ is set to Πᵢⱼ=0. Then (2020), all values of j∈{1, . . . , n} are identified for which Φ*ᵢ=Ψ*ⱼ+ρ*·Dᵢⱼ holds (i.e., all remaining values of j), and stored in a set J. Next (2030), the number of elements in J is counted and denoted sz(J). Then (2040), for all j∈J, the corresponding component Πᵢⱼ is set to Πᵢⱼ=pᵢ/sz(j). It is then checked (2050), if i<n holds. If this is the case (2060), i is incremented i←i+1 and the method iterates back to step (2010). If not, the method concludes and continues in step (1350).

The term “computer” covers any device for the processing of pre-defined calculation instructions. These calculation instructions can be in the form of software, or in the form of hardware, or also in a mixed form of software and hardware.

It is further understood that the procedures cannot only be completely implemented in software as described. They can also be implemented in hardware, or in a mixed form of software and hardware.

1-21. (canceled)

22. A computer-implemented method for obtaining an adversarial input signal to a classifier for classifying input signals obtained from a sensor, wherein the adversarial input signal is obtained from an original input signal, and wherein the adversarial input signal and the original input signal cause the classifier to classify the original input signal as belonging to a first class and the adversarial input signal as belonging to a second class different from the first class, the method comprising the following steps:
modifying the original input signal to yield a modified input signal;
projecting the modified input signal onto a metric ball around the original input signal to yield a projected input signal; and
obtaining the adversarial input signal depending on the projected input signal;
wherein the metric is an at least approximate Wasserstein distance.

23. The method according to claim 22, wherein the projected input signal is determined by minimizing a distance to the modified input signal under a constraint that a distance, according to the at least approximate Wasserstein distance is not larger than a predefined radius of the metric ball.

24. The method according to claim 22, wherein the at least approximate Wasserstein distance is a Wasserstein distance.

25. The method according to claim 23, wherein the minimization is obtained by maximizing a dual problem corresponding to a primal problem that is given by the minimization under the constraints.

26. The method according to claim 22, wherein the at least approximate Wasserstein distance is a Sinkhorn distance which differs from said Wasserstein distance by an entropic term (E_{T}), wherein for any pair of first distribution (P) and second distribution (Q), the entropic term (E_{T}) characterizes an entropy of a distribution Π that satisfies Π1ₙ=P, Π^{T}1ₙ=Q.

27. The method according to claim 23, wherein the projected input signal is determined by solving a convex optimization corresponding to the minimization.

28. The method according to claim 22, wherein the classifier, when provided with an input signal, is configured to output a first classification value corresponding to the first class and a second classification value corresponding to the second class, and wherein the modified input signal causes a difference between the first classification value and the second classification value to be smaller than a difference caused by the original input signal.

29. The method according to claim 22, wherein the classifier, when provided with an input signal, is configured to output a first classification value corresponding to the first class, and wherein the modified input signal causes the first classification value to be smaller than the first classification value caused by the original input signal.

30. The method according to claim 22, wherein the steps of modifying the original input signal and projecting the modified input signal are carried out iteratively by using the projected input signal of a preceding iteration as the original input signal for a subsequent iteration, wherein the step of projecting the modified input signal is carried out after each step of modifying the original input signal.

31. A computer-implemented method for training a classifier having improved accuracy for classifying input signals obtained from a sensor, the method comprising the following steps:
accessing, from a memory, the classifier, the classifier having been trained using a plurality of training input signals, training images being labeled for a plurality of classes;
generating an adversarial input signal, by modifying the original input signal to yield a modified input signal, projecting the modified input signal onto a metric ball around the original input signal to yield a projected input signal, and obtaining the adversarial input signal depending on the projected input signal, wherein the metric is an at least approximate Wasserstein distance; and
further training the classifier to have improved accuracy using at least the adversarial input signal.

32. A computer-implemented method for using a classifier trained for classifying sensor signals, the classifier being trained by: (i) accessing, from a memory, the classifier, the classifier having been trained using a plurality of training input signals, training images being labeled for a plurality of classes, (ii) generating an adversarial input signal, by modifying an original input signal to yield a modified input signal, projecting the modified input signal onto a metric ball around the original input signal to yield a projected input signal, and obtaining the adversarial input signal depending on the projected input signal, wherein the metric is an at least approximate Wasserstein distance, and (iii) further training the classifier to have improved accuracy using at least the adversarial input signal, the method comprising:
receiving a sensor signal including data from a sensor;
determining an input signal which depends on the sensor signal; and
feeding the input signal into the classifier to obtain an output signal that characterizes a classification of the input signal.

33. A computer-implemented method for assessing a robustness of a classifier for classifying for classifying sensor signals, comprising the following steps:
receiving a sensor signal including data from a sensor;
determining an original input signal which depends on the sensor signal;
determining, by the classifier, a first output signal that characterizes a classification of the original input signal;
determining an adversarial input signal by modifying the original input signal to yield a modified input signal, projecting the modified input signal onto a metric ball around the original input signal to yield a projected input signal, and obtaining the adversarial input signal depending on the projected input signal, wherein the metric is an at least approximate Wasserstein distance;
determining, by the classifier, a second output signal that characterizes a classification of the adversarial input signal; and
determining a robustness value depending on the first output signal and on the second output signal.

34. A non-transitory machine-readable storage medium on which is stored a computer program for obtaining an adversarial input signal to a classifier for classifying input signals obtained from a sensor, wherein the adversarial input signal is obtained from an original input signal, and wherein the adversarial input signal and the original input signal cause the classifier to classify the original input signal as belonging to a first class and the adversarial input signal as belonging to a second class different from the first class, the computer program, when executed by a computer, causing the computer to perform the following steps:
modifying the original input signal to yield a modified input signal;
projecting the modified input signal onto a metric ball around the original input signal to yield a projected input signal; and
obtaining the adversarial input signal depending on the projected input signal;
wherein the metric is an at least approximate Wasserstein distance.

35. A classifier for classifying sensor signals, the classifier being trained by:
accessing, from a memory, the classifier, the classifier having been trained using a plurality of training input signals, training images being labeled for a plurality of classes;
generating an adversarial input signal, by:
modifying the original input signal to yield a modified input signal,
projecting the modified input signal onto a metric ball around the original input signal to yield a projected input signal, and
obtaining the adversarial input signal depending on the projected input signal,
wherein the metric is an at least approximate Wasserstein distance; and
further training the classifier to have improved accuracy using at least the adversarial input signal.

36. A training system configured to train a classifier having improved accuracy for classifying input signals obtained from a sensor, the training system configured to:
access, from a memory, the classifier, the classifier having been trained using a plurality of training input signals, training images being labeled for a plurality of classes;
generate an adversarial input signal, by modifying the original input signal to yield a modified input signal, projecting the modified input signal onto a metric ball around the original input signal to yield a projected input signal, and obtaining the adversarial input signal depending on the projected input signal, wherein the metric is an at least approximate Wasserstein distance; and
further train the classifier to have improved accuracy using at least the adversarial input signal.
